(19) United States
(12) Patent Application Publication
(10) Pub. No.: US 2021/0265781 A1
(43) Pub. Date: Aug. 26, 2021

(54) ELECTRICAL CONNECTOR AND TERMINAL MODULE THEREOF

(71) Applicant: Dongguan Luxshare Technologies Co., Ltd, Dongguan City (CN)

(72) Inventors: YunFeng HE, Dongguan City (CN); HongJi CHEN, Dongguan City (CN); HaoHan CHEN, Dongguan City (CN)

(73) Assignee: Dongguan Luxshare Technologies Co., Ltd, Dongguan City (CN)

(21) Appl. No.: 16/921,418

(22) Filed: Jul. 6, 2020

(30) Foreign Application Priority Data
Feb. 25, 2020 (CN) 202010115266.6

(51) Int. Cl. H01R 13/6471; H01R 13/6586; H01R 12/55; H01R 12/71

(52) U.S. Cl. CPC H01R 13/6471; H01R 12/71; H01R 12/55; H01R 13/6586

(57) ABSTRACT

A terminal module comprising a first terminal component and a plurality of second terminal components. The first terminal component comprises a plurality of first terminals and a plurality of engaging parts. Each of the plurality of engaging parts is disposed between two adjacent first terminals. Each of the plurality of second terminal components comprises a second terminal. The plurality of second terminal components is respectively disposed in the corresponding engaging parts. One of the first terminal and the second terminal is a signal terminal while the other is a ground terminal. Passing the second terminal is a corresponding engaging part provided on the first insulation holding part. The first terminal component can be combined with different second terminal components through the assembly configuration of the engaging part. The second terminal component can use the same or different materials as the first terminal component, or can combine with other components.

### CROSS REFERENCE TO RELATED APPLICATION

This application claims the priority benefit of Chinese Patent Application Serial Number CN202010115266.6, filed on Feb. 25, 2020, the full disclosure of which is incorporated herein by reference.

### BACKGROUND

### Technical Field

The present disclosure relates to the technical field of electrical connector, particularly to a terminal module formed by assembling ground terminal and signal terminal.

### Related Art

Electrical connectors are commonly used to connect electronic devices for signal or power transmission between electronic devices. The terminals of a connector are components for signals or power transmission. Conventional grounding terminals are integrally combined with the signal terminal by injection molding, so that the materials covering the signal terminal and the ground terminal are the same. Such a configuration is usually well adapted for a variationless occasion, but is not convenient for different occasions in which different materials or structures should be applied to cover the signal terminal and the ground terminal.

### SUMMARY

The embodiments of the present disclosure provide a terminal module to solve the problem that the current application scenario of the terminal module in the connector is relatively variationless without the ability to handle with complicated configuration.

The present disclosure provides a terminal module comprising a first terminal component and a plurality of second terminal components. The first terminal component comprises a plurality of first terminals, a first insulation holding part holding the plurality of first terminals, and a plurality of engaging parts. The plurality of engaging parts is disposed on the first insulation holding part. Each of the plurality of engaging parts is disposed between two adjacent first terminals. Each of the plurality of second terminal components comprises a second terminal. The plurality of second terminal components is respectively disposed in the corresponding engaging parts. One of the first terminal and the second terminal is a signal terminal while the other is a ground terminal. The first terminals and the second terminals are both parallel disposed in a row.

In the embodiments of the present disclosure, passing the second terminal is a corresponding engaging part provided on the first insulation holding part. The first terminal component can be combined with different second terminal components through the assembly configuration of the engaging part. The second terminal component can use the same or different materials as the first terminal component or can combine with other components for a more extensive application on different occasions.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a perspective view of a terminal module of one embodiment of the present disclosure;

FIG. 2 is an exploded view of the terminal module of one embodiment of the present disclosure;

FIG. 3 is an exploded view from the bottom angle of the terminal module of one embodiment of the present disclosure;

FIG. 4 is a perspective view of a terminal module of another embodiment of the present disclosure;

FIG. 5 is an exploded view of the terminal module in FIG. 4;

FIG. 6 is a front view of the terminal module in FIG. 4;

FIG. 7 is an exploded view of the terminal module in FIG. 6; and

FIG. 8 is a cross-sectional view of the terminal module in FIG. 6 along line A-A.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals are used to refer to the same or similar elements throughout the disclosure.

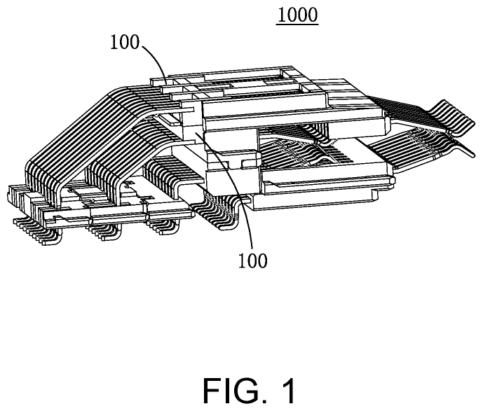

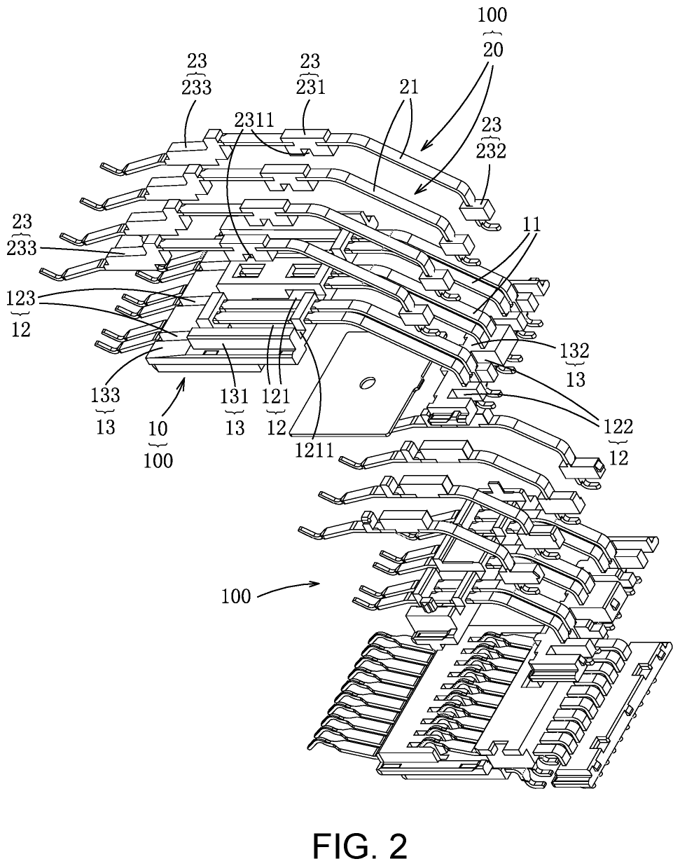

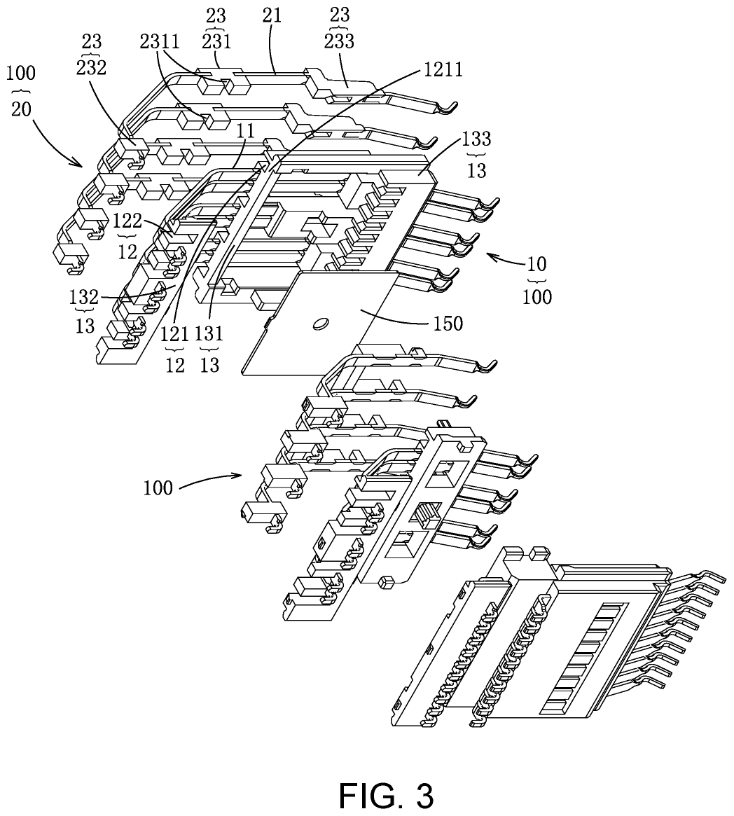

FIG. 1 and FIG. 2 are perspective view and exploded view of a terminal module of one embodiment of the present disclosure. FIG. 3 is an exploded view from the bottom angle of the terminal module of one embodiment of the present disclosure. As shown in the figures, the present disclosure provides a terminal module 100 comprising a first terminal component 10 and a plurality of second terminal components 20. The first terminal component 10 comprises a plurality of first terminals 11, a first insulation holding part 13 holding the plurality of first terminals 11, and a plurality of engaging parts 12. The plurality of engaging parts 12 is disposed on the first insulation holding part 13. Each of the plurality of engaging parts 12 is disposed between two adjacent first terminals 11. Each of the plurality of second terminal components 20 comprises a second terminal 21. The plurality of second terminal components 20 are respectively disposed in the corresponding engaging parts 12. One of the first terminal 11 and the second terminal 21 is a signal terminal while the other is a ground terminal. The first terminals 11 and the second terminals 21 are both parallelly disposed in a row. In this embodiment, the engaging part 12 is in the form of a slot.

In this embodiment, as shown in FIG. 2 and FIG. 3, the plurality of first terminals 11 of the first terminal component 10 are signal terminals. The plurality of first terminals 11 is disposed in pairs. The first terminal component 10 comprises three pairs of first terminals 11. The second terminal 21 of the second terminal component 20 is a ground terminal. The terminal module 100 of this embodiment comprises four second terminal components 20, but the terminal module 100 of the present disclosure is not limited to this. In another embodiment, the first terminal 11 may also be a ground terminal, and the second terminal 21 may also be a signal terminal. A plurality of first terminals 11 is secured in the first insulation holding part 13. By forming the plurality of engaging part 12 in the first insulation holding part 13, and by disposing the second terminal 21 of the second terminal component 20 in the engaging part 12 of the first terminal component 10, the plurality of first terminals 11 and the plurality of second terminals 21 are both parallelly disposed in a row in a transverse direction. Since each engaging part 12 is disposed between two adjacent first terminals 11, the second terminal 21 disposed in the engaging part 12 is disposed between two adjacent first terminals 11. By providing the second terminal 21 (ground terminal) between the adjacent first terminals 11 (signal terminals), the second terminal 21 can shield the first terminal 11 to prevent resonance or crosstalk between adjacent first terminals 11 (signal terminals). In addition, because the second terminal components 20 can be assembled to the first terminal component 10 through the engaging parts 12 of the first terminal component 10, the first terminal component 10 can be combined with the second terminal component 20 in different characteristics as required so that the terminal module 100 of the present application can be put into a more extensive application in different occasions.

As shown in FIG. 2 and FIG. 3, the plurality of first terminals 11 are disposed in the first insulation holding part 13 at intervals. At least one first terminal 11 is disposed between two adjacent engaging parts 12. The plurality of first terminals 11 is disposed in the first insulation holding part 13 through insert molding. A predetermined distance is maintained between the first terminal 11 and the adjacent terminal 11 by the first insulation holding part 13. The first insulation holding part 13 is made of insulating material. With particular mold designing, a plurality of engaging parts 12 can be formed on the first insulation holding part 13 through injection molding. As described above, the first terminals 11 are provided in pairs, and the engaging part 12 is provided corresponding to the second terminal component 20. A pair of the first terminals 11 are provided between two adjacent engaging parts 12. In this embodiment, since the terminal module 100 comprises four second terminal components 20, the first insulation holding part 13 is provided with four engaging parts 12. The three pairs of first terminals 11 of this embodiment are respectively disposed between the four engaging parts 12. The number of the first terminal 11, the second terminal 21, and the engaging part 12 of this embodiment is only an exemplary description and is not used to limit the number of the first terminal 11, the second terminal 21, and the engaging part 12.

Each of the second terminal components 20 also comprises a second insulation holding part 23. The second terminal 21 is disposed in the second insulation holding part 23. The second insulation holding part 23 is disposed in the corresponding engaging part 12. The second terminal 21 is also disposed in the second insulation holding part 23 by insert molding. Each of the second terminal components 20 of this embodiment is a single component which is individually formed. By disposing the second insulation holding part 23 in the corresponding engaging part 12, the second terminal 21 can be disposed between two adjacent pairs of first terminals 11. In this embodiment, the second insulation holding parts 23 are disposed in the corresponding engaging parts 12 at intervals. That is, the second insulation holding parts 23 holding the second terminals 21 are separated from each other and are assembled to the corresponding engaging parts 12 in a vertical direction perpendicular to the transverse direction. As mentioned above, the terminal module 100 comprises three pairs of first terminals 11 and four individual second terminals 21. Thus, in addition to the disposing of second terminal 21 between any two pairs of adjacent first terminals 11, the second terminals 21 can be also provided outside the two pairs of first terminals 11 on the outer left and right. Each pair of first terminals 11 (signal terminals) is surrounded by second terminals 21 (ground terminals) on two sides, so the second terminals 21 can shield the first terminal 11 (signal terminal) to prevent resonance or crosstalk between adjacent first terminals 11.

The first insulation holding part 13 comprises a first connecting body 131 and a second connecting body 132 spaced apart from the first connecting body 131 in a longitudinal direction perpendicular to the transverse and the vertical direction. The first connecting body 131 holds the plurality of first terminals 11, and the second connecting body 132 holds the plurality of first terminals 11. The engaging parts 12 are provided on the first connecting body 131 and the second connecting body 132. The second insulation holding part 23 comprises a first holding body 231 and a second holding body 232. The second terminal 21 is secured to the first holding body 231 and the second holding body 232. The first connecting body 131 is combined with the first holding body 231, and the second connecting body 132 is combined with the second holding body 232. As shown in FIG. 2 and FIG. 3, the first terminal 11 has a long, bent shape. The first connecting body 131 and the second connecting body 132 are separately provided and are spaced apart from each other. The middle part of the first terminal 11 is secured to the first connecting body 131. The tail part of the first terminal 11 is secured to the second connecting body 132. The second terminal 21 also has a long, bent shape. The first holding body 231 and the second holding body 232 are also separately disposed. The middle part of the second terminal 21 is secured to the first holding body 231. The tail part of the second terminal 21 is secured to the second holding body 232. The first connecting body 131 is combined with the first holding body 231, and the second connecting body 132 is combined with the second holding body 232.

Each of the engaging parts 12 comprises a first slot 121 and a second slot 122. The first slot 121 is disposed in the first connecting body 131, and the second slot 122 is disposed in the second connecting body 132. The first slot 121 corresponds to the second slot 122. The first holding body 231 is engaged with the first slot 121. The second holding body 231 is engaged with the second slot 122. In this embodiment, the first slot 121 is provided in the first connecting body 131, and the second slot 122 is provided in the second connecting body 132. In this embodiment, the first slot 121 is a rectangular slot and the length direction of the first slot 121 is parallel to the first terminal 11 in the longitudinal direction. The second slot 122 is also a rectangular slot and the length direction of the second slot 122 is also parallel to the first terminal 11 in the vertical direction. The distance between the first terminal 11 and the first slot 121 adjacent to the first terminal 11 is equal to the distance between the first terminal 11 and the second slot 122 adjacent to the first terminal so that the first slot 121 corresponds to the first holder 231 and the second slot 122 corresponds to the second holder 232. Both the first holding body 231 and the second holding body 232 are rectangular bumps. Since the first holders 231 are engaged with the first slots 121 and the second holders 232 are engaged with the second slots 122, the second terminal component 20 is installed to the first terminal component 10. Through the multi-point connection between the first holder 231 and the first slot 121, and between the second holder 232 and the second slot 122, the assembly of the first terminal component 10 and the second terminal component 20 can be reinforced for the long-sized first terminals 11 and the second terminals 21.

In addition, in this embodiment, a groove 2311 is provided at the bottom of the first holding body 231. The bottom of the first slot 121 is provided with a rib 1211 extending in the transverse direction perpendicular to the length direction of the first slot 121. When the first holding body 231 is engaged with the first slot 121, the groove 2311 of the first holding body 231 is also engaged with the rib 1211 at the bottom of the first slot 121. Since the rib 1211 is perpendicular to the length direction of the first slot 121 as described above, when the groove 2311 of the first holding body 231 is engaged with the rib 1211, the rib 1211 limits the first holding body 231 to prevent the first holding body 231 from moving along the length direction of the first slot 121 when the first holding body 231 is engaged with the first slot 121. In addition, the ribs 1211 can also accurately position the first holding body 231. That is, when the groove 2311 is aligned to engage with the rib 1211, the second holding body 232 can be aligned to engage with the second slot 122 at the same time.

As shown in FIG. 2 and FIG. 3, the first insulation holding part 13 further comprises a third connecting body 133. The third connecting body 133 is connected to the first connecting body 131 and extends in the direction away from the second connecting body 132. That is, the first connecting body 131 is disposed between the second connecting body 132 and the third connecting body 133. The engaging part 12 further comprises a third slot 123 formed in the third connecting body 133. In this embodiment, the third slot 123 is also a rectangular slot and the length direction of the third slot 123 is parallel to the first terminal 11. The second insulation holding part 23 further comprises a third holding body 233. The second terminal 21 is secured to the first holding body 231, the second holding body 232, and the third holding body 233. The third holding body 233 is disposed between the first holding body 231 and the tail end of the second terminal 21. The first holding body 231 is disposed between the second holding body 232 and the third holding body 233. In this embodiment, the third holding body 233 is also a rectangular bump, which corresponds to the third slot 123 of the engaging part 12. The engagement of the third holding body 233 and the third slot 123 could reinforce the assembly of the first terminal component 10 and the second terminal component 20.

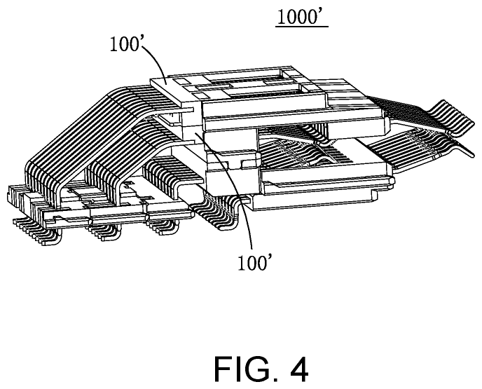

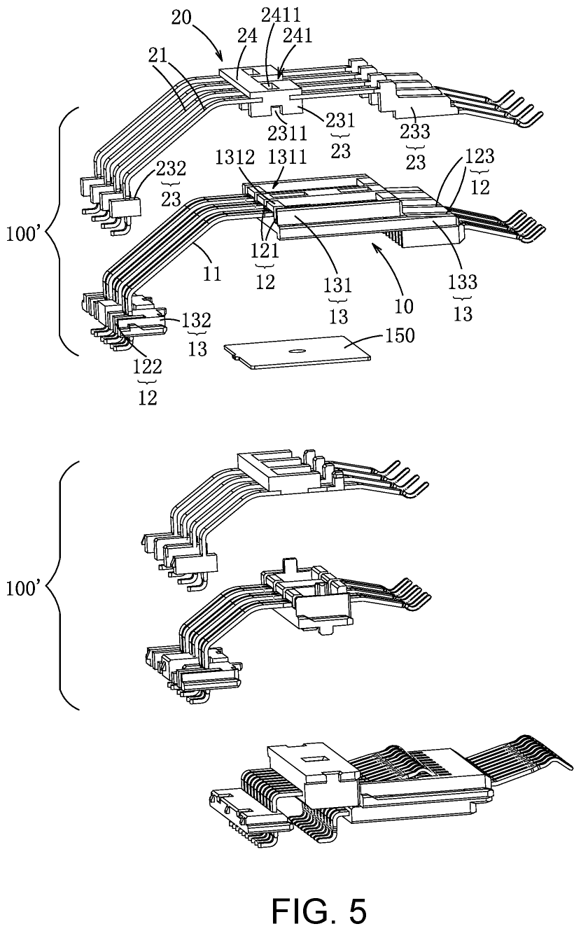

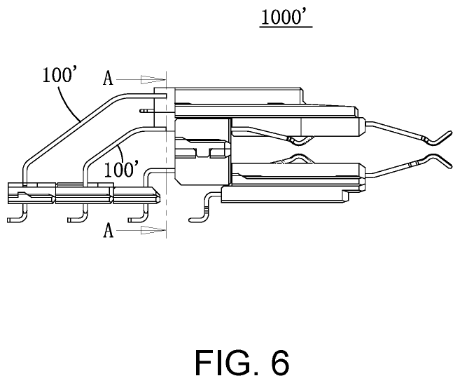

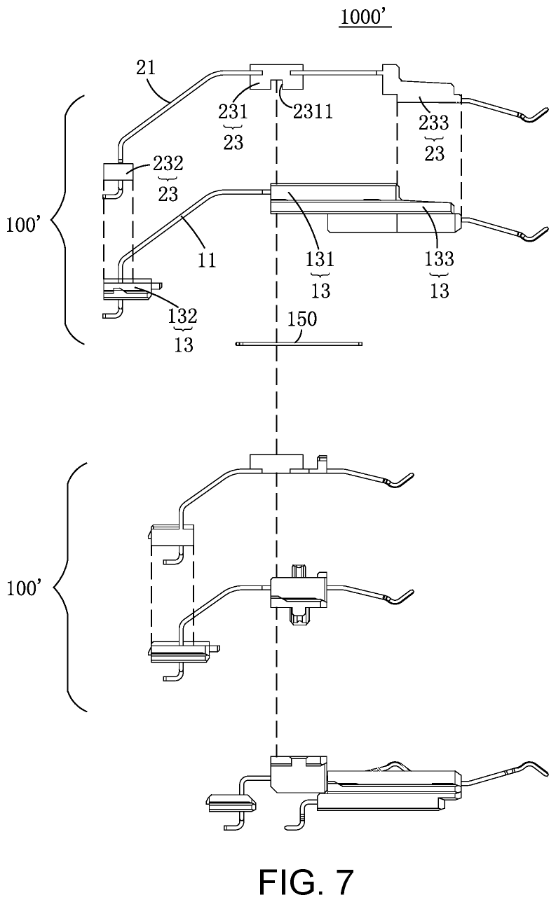

FIG. 4 is a perspective view of a terminal module of another embodiment of the present disclosure. FIG. 5 is an exploded view of the terminal module in FIG. 4. FIG. 6 is a front view of the terminal module in FIG. 4. FIG. 7 is an exploded view of the terminal module in FIG. 6. A shown in the figures, the configuration of the terminal module 100′ of this embodiment is identical to the embodiment shown in FIGS. 2 and 3, so the same symbols would be given to the same components and their descriptions would be omitted. The terminal module 100′ of this embodiment further comprises a connecting member 24. The connecting member 24 is disposed on the second terminals 21 and is disposed on the first holding bodies 231. The connecting member 24 is disposed on the first connecting body 131. As shown in FIG. 5, the connecting member 24 is connecting with each of the first holding bodies 231 of the second insulation holding part 23. The first holding bodies 231 are integrated into a monolithic component through the connecting member 24. The connecting part 24 is provided with a first connecting part 241 connecting to a plurality of second terminals 21. The first connecting body 131 is provided with a second connecting part 1311 connecting to a plurality of first terminals 11. The first connecting part 241 is connected to the second connecting part 1311. The second connecting part 1311 comprises a bump 1312 formed between two adjacent first slots 121. The first connecting part 241 comprises a notch 2411. The bump 1312 is engaged with the notch 2411. The first connecting part 241 is connected to the second connecting part 1311 through the engaging configuration of the notch 2411 of the connecting member 24 with the bump 1312. In this way, in addition to strengthening the assembly, the engaging configuration of the notch 2411 with the bump 1312 can also play a role in limiting and positioning.

In addition, the material of the first insulation holding part 13 may be identical to or different from that of the second insulation holding part 23, such as plastic materials with different dielectric constant and dissipation factor. Thus, the first terminal component 10 can be selected to be combined with the second terminal component 20 having the same or different materials according to requirements, which increases the application range for the terminal module 100 of the present disclosure.

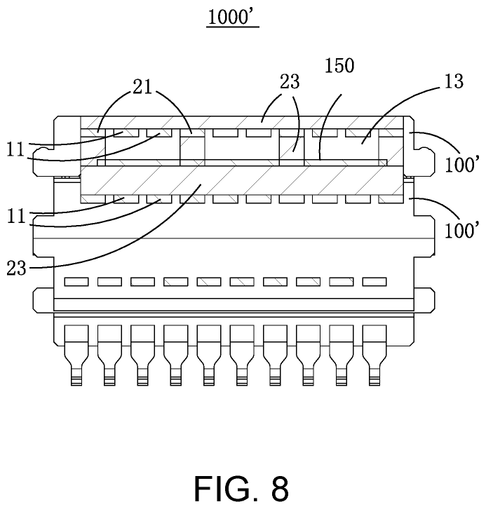

FIG. 8 is a cross-sectional view of the terminal module in FIG. 6 along line A-A. As shown in the figure, the second terminals 21 are provided on two sides of each pair of first terminals 11, so the second terminals 21 are provided between two adjacent pairs of first terminals 11. In this embodiment, the first terminal 11 is a signal terminal, and the second terminal 21 is a ground terminal. Through the ground terminals provided between adjacent signal terminals by the terminal module 100′ of the present application, resonance or crosstalk between adjacent signal terminals are possible to be avoided. The second insulation holding part 23 of the second terminal component 20 of the terminal module 100′ in the upper row and the second insulation holding part 23 of the second terminal component 20 of terminal modules 100′ in the lower row can abut against the four abutting positions as shown in FIG. 8. In another embodiment, the second insulation holding part 23 of the terminal module 100′ in the upper row and the second insulation holding part 23 of the terminal module 100 in the lower row can be abutting with the whole surface.

Back to FIG. 2, FIG. 4, FIG. 5 and FIG. 8, the terminal module 100 of the present application can be applied to the electrical connector 200. The electrical connector 200 of the present application comprises two terminal modules 100 and an electric conductive part 150. The electric conductive part 150 is disposed between the two terminal modules 100 stacked vertically. By disposing the electric conductive part 150 between two terminal modules 100 or 100′, the first terminal 11 (signal terminal) of the two terminal modules 100 or 100′ can be isolated. Therefore, the first terminal 11 of the two terminal modules 100 or 100′ would not be crosstalking or in resonance.

In summary, the present disclosure proposed a terminal module providing ground terminals on two sides of the signal terminal, so that the ground terminals could shield the signal terminal to avoid resonance or crosstalk between adjacent signal terminals. In addition, passing the second terminal is a corresponding engaging part provided on the first insulation holding part. The first terminal component can be combined with different second terminal components through the assembly configuration of the engaging part. The second terminal component can use the same or different materials as the first terminal component or can combine with other components for a more extensive application on different occasions.

It is to be understood that the term “comprises”, “comprising”, or any other variants thereof, is intended to encompass a non-exclusive inclusion, such that a process, method, article, or device of a series of elements not only include those elements but also includes other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A terminal module, comprising:
a first terminal component comprising a plurality of first terminals, a first insulation holding part holding the plurality of first terminals, and a plurality of engaging parts, the plurality of engaging parts being disposed on the first insulation holding part, each of the engaging parts being disposed between two adjacent first terminals; and
a plurality of second terminal components, each of the second terminal components comprising a second terminal, the plurality of second terminal components being respectively disposed in the corresponding engaging parts;
wherein one of the first terminal and the second terminal is a signal terminal while the other is a ground terminal; the first terminals and the second terminals are both parallelly disposed in a row.

2. The terminal module according to claim 1, wherein the plurality of first terminals are disposed in the first insulation holding part at intervals; at least one of the plurality of first terminals is provided between two adjacent engaging parts.

3. The terminal module according to claim 1, wherein each of the second terminal components comprises a second insulation holding part; the second terminal is disposed in the second insulation holding part disposed in the corresponding engaging part.

4. The terminal module according to claim 3, wherein the first insulation holding part comprises a first connecting body and a second connecting body spaced apart from the first connecting body; the first connecting body holds the plurality of first terminals; the second connecting body holds the plurality of first terminals; the engaging parts are respectively provided on the first connecting body and the second connecting body; the second insulation holding part comprises a first holding body and a second holding body; the second terminal is secured to the first holding body and the second holding body; the first connecting body is engaged with the first holding body; the second connecting body is engaged with the second holding body.

5. The terminal module according to claim 4, wherein each of the engaging parts comprises a first slot and a second slot; the first slot is disposed in the first connecting body; the second slot is disposed in the second connecting body; the first slot corresponds to the second slot; the first holding body is engaged with the first slot; the second holding body is engaged with the second slot.

6. The terminal module according to claim 4 further comprising a connecting member disposed on the second terminals; the connecting member is disposed on the first holding bodies; the connecting member is disposed on the first connecting body.

7. The terminal module according to claim 6, wherein the connecting member comprises a first connecting part connecting to the plurality of second terminals; the first connecting body comprises a second connecting part connecting to the plurality of first terminals; the first connecting part is connected to the second connecting part.

8. The terminal module according to claim 7, wherein the second connecting part comprises a bump formed between two adjacent first slots; the first connecting part comprises a notch; the bump is engaged with the notch.

9. The terminal module according to claim 1, wherein the second insulation holding parts are disposed in the corresponding engaging parts at intervals.

10. The terminal module according to claim 9, wherein two first terminals are provided between two adjacent second terminals.

11. The terminal module according to claim 1, wherein the engaging part is in a form of a slot.

12. An electrical connector comprising:
two terminal modules; each of the terminal modules comprising:
a first terminal component comprising a plurality of first terminals, a first insulation holding part holding the plurality of first terminals, and a plurality of engaging parts, the plurality of engaging parts being disposed on the first insulation holding part, each of the engaging parts being disposed between two adjacent first terminals; and
a plurality of second terminal components, each of the second terminal components comprising a second terminal, the plurality of second terminal components being respectively disposed in the corresponding engaging parts;
wherein one of the first terminal and the second terminal is a signal terminal while the other is a ground terminal; the first terminals and the second terminals are both parallelly disposed in a row; and
an electric conductive part;
wherein the electric conductive part is disposed between the two terminal modules stacked vertically.

13. The electrical connector according to claim 12, wherein the plurality of first terminals are disposed in the first insulation holding part at intervals; at least one of the plurality of first terminals is provided between two adjacent engaging parts.

14. The electrical connector according to claim 12, wherein each of the second terminal components comprises a second insulation holding part; the second terminal is disposed in the second insulation holding part disposed in the corresponding engaging part.

15. The electrical connector according to claim 14, wherein the first insulation holding part comprises a first connecting body and a second connecting body spaced apart from the first connecting body; the first connecting body holds the plurality of first terminals; the second connecting body holds the plurality of first terminals; the engaging parts are respectively provided on the first connecting body and the second connecting body; the second insulation holding part comprises a first holding body and a second holding body; the second terminal is secured to the first holding body and the second holding body; the first connecting body is engaged with the first holding body; the second connecting body is engaged with the second holding body.

16. The electrical connector according to claim 15, wherein each of the engaging parts comprises a first slot and a second slot; the first slot is disposed in the first connecting body; the second slot is disposed in the second connecting body; the first slot corresponds to the second slot; the first holding body is engaged with the first slot; the second holding body is engaged with the second slot.

17. The electrical connector according to claim 15 further comprising a connecting member disposed on the second terminal of each of the plurality of second terminal components; the connecting member is disposed on the first holding bodies; the connecting member is disposed on the first connecting body.

18. The electrical connector according to claim 17, wherein the connecting member comprises a first connecting part connecting to the plurality of second terminals; the first connecting body comprises a second connecting part connecting to the plurality of first terminals; the first connecting part is connected to the second connecting part.

19. The electrical connector according to claim 18, wherein the second connecting part comprises a bump formed between two adjacent first slots; the first connecting part comprises a notch; the bump is engaged with the notch.

20. The electrical connector according to claim 12, wherein the second insulation holding parts are disposed in the corresponding engaging parts at intervals.

21. The electrical connector according to claim 20, wherein two first terminals are provided between two adjacent second terminals.

22. The electrical connector according to claim 12, wherein the engaging part is in a form of a slot.
